(19) United States
(12) Patent Application Publication
(10) Pub. No.: US 2025/0015344 A1
(43) Pub. Date: Jan. 9, 2025

(54) SOLID ELECTROLYTE MATERIAL FOR FLUORIDE ION BATTERIES AND PRODUCTION METHOD FOR SOLID ELECTROLYTE MATERIAL FOR FLUORIDE ION BATTERIES

(71) Applicant: NICHIA CORPORATION, Anan-shi (JP)

(72) Inventor: Shoma HATA, Tokushima-shi (JP)

(73) Assignee: NICHIA CORPORATION, Anan-shi (JP)

(21) Appl. No.: 18/715,469

(22) PCT Filed: Nov. 7, 2022
(86) PCT No.: PCT/JP2022/041419

§ 371 Date: May 31, 2024

(30) Foreign Application Priority Data
Dec. 2, 2021 (JP) 2021-196398

(51) Int. Cl. H01M 10/0562; C01F 17/36

(52) U.S. Cl. CPC H01M 10/0562; C01F 17/36; C01P 2002/50; C01P 2002/72; C01P 2006/40; H01M 2300/008

(57) ABSTRACT

Provided is a solid electrolyte material for fluoride ion batteries which has high fluoride ion conductivity. The solid electrolyte material for fluoride ion batteries includes a metal composite fluoride that includes, as its main phase, a crystal structure containing, in a fluorite structure containing a fluoride ion, a lanthanoid metal ion, and an alkali earth metal ion, an adduct ion having an ion radius larger than that of the alkali earth metal ion. The metal composite fluoride has a composition in which a ratio of a number of moles of the fluoride ion to a total number of moles of the lanthanoid metal ion, the alkali earth metal ion, and the adduct ion is greater than 1.87 and is smaller than 3, and a ratio of a number of moles of the adduct ion to a number of moles of the alkali earth metal ion is smaller than 1.

### TECHNICAL FIELD

The present disclosure relates to a solid electrolyte material for fluoride ion batteries, and a method for producing the solid electrolyte material for fluoride ion batteries.

### BACKGROUND ART

A fluoride ion solid battery utilizing a reaction of fluoride ions has been known as a battery having a high energy density at a high voltage. A fluoride ion battery operates at a high temperature of, for example, 150° C. or higher while there has been a problem that, in a low temperature state, the ion conductivity of a solid electrolyte therein is low and the fluoride ion battery does not therefore operate. Relating to this, for example, a solid electrolyte material that has a tysonite structure is proposed in JP201877992A.

### SUMMARY OF THE INVENTION

### Problem to be Solved by the Invention

An object of one aspect of the present disclosure is to provide a solid electrolyte material for fluoride ion batteries that has high ion conductivity for fluoride ions.

### Means for Solving Problem

A first aspect thereof is a solid electrolyte material for fluoride ion batteries, including a metal composite fluoride that includes, as its main phase, a crystal structure including adduct ions in a fluorite structure that includes a fluoride ion, a lanthanoid metal ion, and an alkali earth metal ion. In the solid electrolyte material, the adduct ion has an ion radius that is larger than that of the alkali earth metal ion. The metal composite fluoride has a composition in which the ratio of the number of moles of the fluoride ion to the total number of moles of the lanthanoid metal ion, the alkali earth metal ion, and the adduct ion is greater than 1.87 and smaller than 3, and in which the ratio of the number of moles of the adduct ion to the number of moles of the alkali earth metal ion is smaller than 1.

A second aspect thereof is a solid electrolyte layer for fluoride ion batteries, the solid electrolyte layer including the solid electrolyte material of the first aspect. A third aspect thereof is a fluoride ion battery including a solid electrolyte layer that includes the solid electrolyte material of the first aspect, a positive electrode, and a negative electrode.

A fourth aspect thereof is a production method for a solid electrolyte for fluoride ion batteries, including the steps of preparing a mixture that includes a lanthanoid metal fluoride, an alkali earth metal fluoride, and a fluoride of the adduct ion, and performing a heat-treatment of the mixture at a temperature of 200° C. or higher and 1,000° C. or lower to obtain a metal composite fluoride. Assuming that the content of the lanthanoid metal ion included in the lanthanoid metal fluoride is p mol, the content of the alkali earth metal ion included in the alkali earth metal fluoride is q mol, the content of the adduct ion included in the fluoride of the adduct ion is r mol, and the valence of the adduct ion is n, the mixture includes the lanthanoid metal fluoride, the alkali earth metal fluoride, and the fluoride of the adduct ion at such content ratios that p, q, r and n satisfy 1.87<(3p+2q+nr)/(p+q+r)<3. The adduct ion has an ion radius that is larger than an ion radius of the alkali earth metal ion. The metal composite fluoride has, as its main phase, a crystal structure that includes the adduct ion in the fluorite structure.

### Effect of the Invention

According to one aspect of the present disclosure, a solid electrolyte material for fluoride ion batteries that has high ion conductivity for fluoride ions can be provided.

### BRIEF DESCRIPTION OF DRAWINGS

FIG. 1 is an example of X-ray diffraction spectra of solid electrolyte materials according to Example 1 to Example 3 and Comparative Examples 1 to 4.

FIG. 2 is an example of X-ray diffraction spectra of solid electrolyte materials according to Comparative Example 1, Comparative Example 2, and Examples 4 to 6.

FIG. 3 is an example of X-ray diffraction spectra of solid electrolyte materials according to Comparative Example 1, Comparative Example 2, Example 1, and a raw material compound.

FIG. 4 is an example of X-ray diffraction spectra of solid electrolyte materials according to Comparative Example 1 and Comparative Example 5 to Comparative Example 7.

FIG. 5 is an example of X-ray diffraction spectra of solid electrolyte materials according to Comparative Example 1 and Comparative Example 8 to Comparative Example 10.

### MODES FOR CARRYING OUT THE INVENTION

The term “step” as used herein includes not only an independent step but also a step at which the initial purpose of the step is achieved even in the case where the step is not clearly distinguishable from other steps. In the case where plural materials corresponding to each component are present in a composition, the content of each component in the composition means the total amount of the plural materials that are present in the composition unless otherwise noted. As to the upper limit and the lower limit of a numerical value range descried herein, values exemplified as the numerical value range can each be optionally selected to be combined with each other. Embodiments of the present invention will be described below in detail. The embodiments described below, however, exemplify a solid electrolyte material for fluoride ion batteries and a method for producing the solid electrolyte material for fluoride ion batteries, to embody the technical idea of the present invention, and the present invention is not limited to the solid electrolyte material for fluoride ion batteries and the method for producing the solid electrolyte material for fluoride ion batteries that will be described below.

### Solid Electrolyte Material

The solid electrolyte material may include a metal composite fluoride that has, as its main phase, a crystal structure including an adduct ion having an ion radius larger than that of an alkali earth metal ion, in a fluorite structure that includes a fluoride ion, a lanthanoid metal ion, and the alkali earth metal ion. The metal composite fluoride may have a composition in which the ratio of the number of moles of the fluoride ion to the total number of moles of the lanthanoid metal ion, the alkali earth metal ion, and the adduct ion, for example, is greater than 1.87 and smaller than 3, and in which the ratio of the number of moles of the adduct ion to the number of moles of the alkali earth metal ion is smaller than 1. The solid electrolyte material may be, for example, a material that is included in a solid electrolyte layer included in a fluoride ion battery.

The metal composite fluoride included in the solid electrolyte material further includes the adduct ion in the fluorite structure that includes the fluoride ion, the lanthanoid metal ion, and the alkali earth metal ion. The adduct ion may be solid-solved in the fluorite structure. The fluorite structure is generally an ionic crystal structure constituted by the alkali earth metal ion and the fluoride ion at ratios of 1:2. In the fluorite structure of the metal composite fluoride, the lanthanoid metal ion is solid-solved in addition to the alkali earth metal ion and the fluoride ion. The ion conductivity is improved by the solid-solving of the lanthanoid metal ion in the fluorite structure. This improvement can be thought to be caused by, for example, the following. The solid-solving of the lanthanoid metal ion increases the content ratio of the fluoride ion in the fluorite structure and the fluoride ion is thereby caused to be present at an interstitial position. The fluoride ion present at the interstitial position and the fluoride ion present at the regular sites are successively moved like a chain reaction, so that conduction of the fluoride ions through interstitial positions occurs due to conduction mechanism of interstitialcy diffusion.

The metal composite fluoride has, as its main phase, a crystal structure that includes the adduct ion having an ion radius larger than that of the alkali earth metal ion in the fluorite structure that includes the fluoride ion, the lanthanoid metal ion, and the alkali earth metal ion (hereinafter, referred to also as “specific crystal structure”), and can thereby exhibits higher ion conductivity. This can be thought to be because, for example, the adduct ion having the ion radius larger than that of the alkali earth metal ion is included in the crystal structure, so that the lattice constant of the crystal of the metal composite fluoride is increased, which facilitates the move, in the crystal, of the fluoride ion responsible for the ion conduction.

The metal composite fluoride as, as its main phase, the specific crystal structure. The content rate of the specific crystal structure in the crystal phase of the metal composite fluoride may be, for example, 60% by mole or higher. The content rate of the specific crystal structure in the crystal phase of the metal composite fluoride may be preferably 80% by mole or higher, or 100% by mole.

The fact that the metal composite fluoride includes, in its composition, the lanthanoid metal ion, the alkali earth metal ion, and the adduct ion may be confirmed together with the content ratios of the above by, for example, executing an inductively coupled plasma (ICP) atomic emission spectroscopy analysis for the metal composite fluoride. Because the fluorite type structure is generally an ionic crystal, it can be considered that the detection of the lanthanoid metal ion, the alkali earth metal ion, and the adduct ion by the ICP atomic emission spectroscopy analysis indicates that these are present as ions in the crystal structure of the metal composite fluoride.

In the composition of the metal composite fluoride, the ratio of the number of moles of the fluorine ion to the total number of moles of the lanthanoid metal ion, the alkali earth metal ion, and the adduct ion (hereinafter, referred to also as “total number of moles of the cations”) may be greater than 1.87 and smaller than 3. The ratio of the number of moles of the fluorine ion to the total number of moles of the cations in the composition of the metal composite fluoride may be preferably 1.9 or greater, or 2 or greater, and may more preferably be greater than 2. This ratio may be preferably 2.8 or smaller, or 2.6 or smaller, and may be more preferably 2.3 or smaller, 2.2 or smaller, or 2.1 or smaller. When the ratio of the number of moles of the fluorine ion is in the above ranges, the ion conductivity tends to be further improved. The number of moles of the fluorine ion included in the composition of the metal composite fluoride is calculated assuming that the total number of moles of the lanthanoid metal ion, the alkali earth metal ion and the adduct ion is 1 based on the metal ion amounts quantified by the ICP atomic emission spectroscopy analysis method, and taking into consideration the valence of each of these.

For example, it is assumed that La³⁺ that is the lanthanoid metal ion, Ba²⁺ that is the alkali earth metal ion, and Cs⁺ that is the adduct ion are detected by the ICP atomic emission spectroscopy analysis method at the ratios of the numbers of moles respectively of 1:1:1. In this case, assuming that the total number of moles of the lanthanum ion, the barium ion, and the cesium ion is 1, the detected amounts of the lanthanum ion, the barium ion, and the cesium ion are each 1/3 on a mole basis. Assuming that the valence of the lanthanum ion is 3, the valence of the barium ion is 2, and the valence of the cesium ion is 1, the number of moles of the fluoride ion included in the composition of the metal composite fluoride is calculated as

$$( 1 / 3 ) \times 3 + ( 1 / 3 ) \times 2 + ( 1 / 3 ) \times 1 = 2.$$

Examples of a lanthanoid metal that provides the lanthanoid metal ion included in the metal composite fluoride include lanthanum (La), cerium (Ce), praseodymium (Pr), neodymium (Nd), samarium (Sm), and the like. The lanthanoid metal includes preferably at least lanthanum, may further include cerium, samarium, and the like, and may include more preferably at least lanthanum. The ratio of the number of moles of lanthanum ion to the total number of moles of the lanthanoid metal ion included in the metal composite fluoride may be, for example, 0.5 or greater, and may be preferably 0.7 or greater, or 0.9 or greater. The upper limit of the ratio of the number of moles of lanthanum ion may be, for example, 1.

The ratio of the number of moles of the lanthanoid metal ion in the composition of the metal composite fluoride, to the total number of moles of the lanthanoid metal ion, the alkali earth metal ion, and the adduct ion, may, for example, exceed 0 and be smaller than 0.8. The ratio of the number of moles of the lanthanoid metal ion may be preferably 0.05 or greater, 0.1 or greater, 0.2 or greater, or 0.28 or greater, and may be preferably 0.6 or smaller, 0.4 or smaller, 0.34 or smaller, 0.32 or smaller, or 0.3 or smaller. When the ratio of the number of moles of the lanthanoid metal ion is in the above ranges, the main phase of the metal composite fluoride can have the fluorite type structure.

Examples of an alkali earth metal that provides the alkali earth metal ion included in the metal composite fluoride include calcium (Ca), strontium (Sr), barium (Ba), and the like. The alkali earth metal includes preferably at least barium, may further include strontium, calcium, and the like, and may include more preferably at least barium. The ratio of the number of moles of barium ions to the total number of moles of the alkali earth metal ion included in the metal composite fluoride may be, for example, 0.5 or greater, and may be preferably 0.7 or greater, or 0.9 or greater. The upper limit of the ratio of the number of moles of the barium ions may be, for example, 1.

The ratio of the number of moles of the alkali earth metal ion in the composition of the metal composite fluoride, to the total number of moles of the lanthanoid metal ion, the alkali earth metal ion, and the adduct ion, may be, for example, 0.2 or greater and smaller than 1. The ratio of the number of moles of the alkali earth metal ion may be preferably 0.4 or greater, or 0.45 or greater, and may be preferably 0.8 or smaller, 0.6 or smaller, 0.55 or smaller, or 0.5 or smaller. When the ratio of the number of miles of the alkali earth metal ion is in the above ranges, the main phase of the metal composite fluoride can have the fluorite type structure.

The ratio of the number of moles of the lanthanoid metal ion to the number of moles of the alkali earth metal ion in the composition of the metal composite fluoride may be, for example, greater than 0 and be 4 or smaller. The ratio of the number of moles of the lanthanoid metal ion to the number of moles of the alkali earth metal ion may be preferably 0.1 or greater, 0.3 or greater, 0.5 or greater, or 0.55 or greater, and may be preferably 1.5 or smaller, 1.0 or smaller, 0.8 or smaller, or 0.7 or smaller.

The adduct ion included in the metal composite fluoride may be solid-solved in the crystal structure included in the metal composite fluoride as its main phase and may be substantially uniformly distributed in the overall crystal structure included in the metal composite fluoride as its main phase. The expression “the adduct ion is solid-solved in the crystal structure included in the metal composite fluoride as its main phase” in the above means that some of the cations constituting the crystal structure included in the metal composite fluoride as its main phase are each replaced with the adduct ion.

The adduct ion included in the metal composite fluoride only has to be a cation having an ion radius that is larger than that of the alkali earth metal ion constituting the fluorite structure included in the metal composite fluoride. The cation may be an inorganic ion such as a metal ion or may be an organic cation. As to the ion radius of a cation, the value known through literatures may be employed for a metal ion. For example, the ion radius of a calcium ion is 0.114 nm to 0.126 nm, the ion radius of a strontium ion is 0.132 nm to 0.140 nm, and the ion radius of a barium ion is 0.149 nm to 0.175 nm. The ion radius of an organic cation is determined by a simulation calculation such as a density functional theory (DFT). For example, the ion radius of a tetramethylammonium ion determined using this method is about 0.18 nm to about 0.27 nm.

Examples of the adduct ion may include, for example, an inorganic ion such as a cesium (Cs) ion (the ion radius: 0.181 nm to 0.202 nm), a rubidium (Rb) ion (the ion radius: 0.166 nm to 0.175 nm), or an ammonium ion (the ion radius: 0.175 nm), and an organic cation such as a methylammonium ion, a dimethylammonium ion, a trimethylammonium ion, a tetramethylammonium ion, an ethylammonium ion, a diethylammonium ion, a triethylammonium ion, or a tetraethylammonium ion. The adduct ion may include at least one selected from the group consisting of the cesium ion, the methylammonium ion, the dimethylammonium ion, the trimethylammonium ion, the tetramethylammonium ion, the ethylammonium ion, the diethylammonium ion, the triethylammonium ion, and the tetraethylammonium ion, and may include preferably at least the cesium ion.

The ratio of the number of moles of cesium ions to the total number of moles of the adduct ion included in the metal composite fluoride may be, for example, 0.5 or greater, and may be preferably 0.6 or greater, 0.8 or greater, 0.9 or greater, or 0.98 or greater. The upper limit of the ratio of the number of moles of cesium ions may be, for example, 1.

The adduct ion has an ion radius that is larger than that of the alkali earth metal ion. The ratio of the ion radius of the adduct ion to the ion radius of the alkali earth metal ion may be, for example, greater than 1 and equal to or smaller than 3. The ratio of the ion radius of the adduct ion to that of the alkali earth metal ion may be preferably 1.05 or greater, 1.06 or greater, 1.08 or greater, 1.09 or greater, or 1.1 or greater, and may be preferably 2 or smaller, 1.6 or smaller, 1.2 or smaller, or 1.15 or smaller.

The ratio of the number of moles of the adduct ion in the composition of the metal composite fluoride, to the total number of moles of the lanthanoid metal ion, the alkali earth metal ion, and the adduct ion, may be, for example, greater than 0 and smaller than 0.38. The ratio of the number of moles of the adduct ion may be preferably 0.05 or greater, 0.2 or greater, or 0.25 or greater, and may be preferably 0.35 or smaller, 0.3 or smaller, or 0.28 or smaller.

The ratio of the number of moles of the adduct ion in the composition of the metal composite fluoride, to the number of moles of the alkali earth metal ion, may be, for example, greater than 0 and smaller than 1. The ratio of the number of moles of the adduct ion to the number of moles of the alkali earth metal ion may be preferably 0.1 or greater, 0.2 or greater, or 0.4 or greater, and may be preferably 0.9 or smaller, 0.7 or smaller, 0.6 or smaller, or 0.5 or smaller. The ratio of the number of moles of the adduct ion in the composition of the metal composite fluoride, to the number of moles of the lanthanoid metal ion, may be, for example, greater than 0 and 1.5 or smaller. The ratio of the number of moles of the adduct ion to the number of moles of the lanthanoid metal ion may be preferably 0.1 or greater, 0.3 or greater, 0.4 or greater, 0.5 or greater, 0.6 or greater, or 0.7 or greater, and may be preferably 1.2 or smaller, or 1.0 or smaller.

The metal composite fluoride may have a composition represented by Formula (1) as below.

Ln_{1-x-y}MₓA_{y}F_{z} (1)

In Formula (1), Ln represents the lanthanoid metal ion, M represents the alkali earth metal ion, and A represents the adduct ion. x, y, and z may satisfy 0<x<1, 0<y<1, 0<x+y<1, and 1.87<z<3. x and y may satisfy preferably 0.4≤x<1, 0.4<x+y<1, and 0<y<0.38. z may satisfy preferably 2≤z≤2.6. x and y may satisfy more preferably 0.4≤x<0.8, 0.4<x+y<1, and 0.05<y≤0.35. z may satisfy preferably 2<z≤2.3.

The details of each of the lanthanoid metal ion, the alkali earth metal ion, and the adduct ion in Formula (1) are described above.

In X-ray diffraction (XRD) measurement measured using a CuKα line, the solid electrolyte material may have peaks at positions such as 2θ=25.3°±1°, 29.3°±1°, 41.9°±1°, and 49.6°+1°. The solid electrolyte material may have preferably at least two of these peaks, more preferably at least three of these peaks, and further preferably at least four of these peaks. The solid electrolyte material can be regarded as including the fluorite structure based on the fact that the solid electrolyte material has the peaks at the above positions.

The volume average particle size of the solid electrolyte material may be, for example, 1 nm or larger and 100 μm or smaller, and may be preferably 20 nm or larger and 10 μm or smaller. The volume average particle size of the solid electrolyte material may be obtained as the particle size that corresponds to 50% of the cumulative volume from the small size side in the cumulative particle size distribution on a volume basis. The cumulative particle size distribution on a volume basis is measured using, for example, a laser diffraction particle size distribution measuring apparatus.

### Method for Producing Solid Electrolyte Material for Fluoride Ion Batteries

A method for producing the solid electrolyte material for fluoride ion batteries may include a providing step of providing a mixture that includes a lanthanoid metal ion source, an alkali earth metal ion source, and an adduct ion source, and a heat treatment step of performing heat treatment of the mixture at a predetermined temperature to obtain a metal composite fluoride. The obtained metal composite fluoride may have, as its main phase, the crystal structure that includes the adduct ion in the fluorite type structure including the lanthanoid metal ion, the alkali earth metal ion, and the fluoride ion. The adduct ion may have an ion radius that is larger than that of the alkali earth metal ion. At least one of the lanthanoid metal ion source, the alkali earth metal ion source, or the adduct ion source may include the fluoride ion.

In the providing step, the mixture including the lanthanoid metal ion source, the alkali earth metal ion source, and the adduct ion source is provided. The details of each of the lanthanoid metal included in the lanthanoid metal ion source, the alkali earth metal included in the alkali earth metal ion source, and the adduct ion included in the adduct ion source are described above.

In one aspect, the lanthanoid metal ion source may include a lanthanoid metal fluoride, the alkali earth metal ion source may include an alkali earth metal fluoride, and the adduct ion source may include a fluoride of the adduct ion. Assuming that the content of the lanthanoid metal ion included in the lanthanoid metal fluoride is p mol, the content of the alkali earth metal ion included in the alkali earth metal fluoride is q mol, the content of the adduct ion included in the fluoride of the adduct ion is r mol, and the valence of the adduct ion is n, the content ratios of the lanthanoid metal fluoride, the alkali earth metal fluoride, and the fluoride of the adduct ion in the mixture may be such content ratios that p, q, r and n satisfy 1.87<(3p+2q+nr)/(p+q+r)<3. With the mixture including the lanthanoid metal fluoride, the alkali earth metal fluoride, and the fluoride of the adduct ion at the above content ratios, the ratio of the number of moles of the fluoride ion in the composition of the obtained metal composite fluoride, to the total number of moles of the lanthanoid metal ion, the alkali earth metal ion, and the adduct ion, is greater than 1.87 and smaller than 3. The above (3p+2q+nr)/(p+q+r) may be preferably 1.9 or greater, or 2 or greater, and may be more preferably greater than 2. The above (3p+2q+nr)/(p+q+r) may be preferably 2.8 or smaller, or 2.6 or smaller, and may be more preferably 2.3 or smaller.

In one aspect, in the case where it is assumed that the total of the number of moles of the lanthanoid metal ion included in the lanthanoid metal source, the number of moles of the alkali earth metal ion included in the alkali earth metal source, and the number of moles of the adduct ion included in the adduct ion source is 1, the mixture may have a composition in which the ratio of the number of moles of the fluoride ions included in the mixture is greater than 1.87 and smaller than 3. The ratio of the number of moles of the fluoride ions in the mixture may be preferably 1.9 or greater, or 2 or greater, and may be more preferably greater than 2. This ratio may be preferably 2.8 or smaller, or 2.6 or smaller, and may be more preferably 2.3 or smaller.

Examples of the lanthanoid metal ion source included in the mixture can include a lanthanoid metal fluoride, a lanthanoid metal chloride, a lanthanoid metal hydroxide, a lanthanoid metal oxide, and the like. The lanthanoid metal ion source may be a hydrate. The lanthanoid metal ion source may include preferably at least a lanthanoid metal fluoride. The ratio of the number of moles of the lanthanoid metal fluoride to the total number of moles of the lanthanoid metal ion source, relative to the number of moles of the lanthanoid metal, may be, for example, 0.2 or greater, and may be preferably 0.8 or greater. The upper limit of the ratio of the number of moles of the lanthanoid metal fluoride may be, for example, 1.

The purity of the lanthanoid metal ion source may be, for example, 50% or higher, and may be preferably 80% or higher. The upper limit of the purity of the lanthanoid metal ion source may be, for example, 100%.

Examples of the alkali earth metal ion source included in the mixture may include an alkali earth metal fluoride, an alkali earth metal chloride, an alkali earth metal hydroxide, an alkali earth metal oxide, and the like. The alkali earth metal ion source may be a hydrate. The alkali earth metal ion source may include preferably at least an alkali earth metal fluoride. The ratio of the number of moles of the alkali earth metal fluoride to the total number of moles of the alkali earth metal ion source, relative to the number of moles of the alkali earth metal, may be, for example, 0.2 or greater, and may be preferably 0.8 or greater. The upper limit of the ratio of the number of moles of the alkali earth metal fluoride may be, for example, 1.

The purity of the alkali earth metal ion source may be, for example, 50% or higher, and may be preferably 80% or higher. The upper limit of the purity of the alkali earth metal ion source may be, for example, 100%.

Examples of the adduct ion source included in the mixture can include a fluoride of the adduct ion, a chloride of the adduct ion, a hydroxide of the adduct ion, an oxide of the adduct ion, and the like. The adduct ion source may be a hydrate. The adduct ion source may include preferably at least a fluoride of the adduct ion. The ratio of the number of moles of the fluoride of the adduct ion to the total number of moles of the adduct ion source, relative to the number of moles of the adduct ion, may be, for example, 0.2 or greater, and may be preferably 0.8 or greater. The upper limit of the ratio of the number of moles of the fluoride of the adduct ion may be, for example, 1.

The purity of the adduct ion source may be, for example, 50% or higher and may be preferably 80% or higher. The upper limit of the purity of the adduct ion source may be, for example, 100%.

As to the mixing ratios of the lanthanoid metal ion source, the alkali earth metal ion source, and the adduct ion source in the mixture, the ratio of the number moles of the lanthanoid metal ion included in the lanthanoid metal ion source to the total number of moles of the lanthanoid metal ion included in the lanthanoid metal ion source, the alkali earth metal ion included in the alkali earth metal ion source, and the adduct ion included in the adduct ion source (the total number of moles of the cations) may be, for example, greater than 0 and be smaller than 0.8 moles. The ratio of the number of moles of the lanthanoid metal ion to the total number of moles of the cations may be preferably 0.05 or greater, or 0.1 or greater, and may be preferably 0.6 or smaller, or 0.4 or smaller. The ratio of the number of moles of the alkali earth metal ion to the total number of moles of the cations may be, for example, 0.2 or greater and smaller than 1. The ratio of the number of moles of the alkali earth meatal ion to the total number of moles of the cations may be preferably 0.4 or greater, and may be preferably 0.8 or smaller. The ratio of the number of moles of the adduct ion to the total number of moles of the cations may be, for example, greater than 0 and be smaller than 0.38. The ratio of the number of moles of the adduct ion to the total number of moles of the cations may be preferably 0.05 or greater, or 0.2 or greater, and may be preferably 0.35 or smaller, or 0.3 or smaller.

The ratio of the content of the lanthanoid metal ion to that of the alkali earth metal ion in the mixture may be, for example, greater than 0 and be 4 or smaller. The ratio of the content of the lanthanoid metal ion to that of the alkali earth metal ion therein may be preferably 0.1 or greater, or 0.3 or greater, and may be preferably 1.5 or smaller, or 1.0 or smaller.

The mixture may be prepared by weighing the lanthanoid metal ion source, the alkali earth metal ion source, and the adduct ion source to each establish a desired blending ratio and thereafter mixing these with each other using a mixing method that uses a boll mill or the like, a mixing method that uses a mixing machine such as a Henschel mixer or a V-type blender, or the like. The mixing may be a dry mixing, or may be a wet mixing with a solvent or the like added thereto. The mixture may be undergone a drying process. The drying process may be, for example, thermal drying, reduced pressure drying, freeze-drying, or the like, or may be a combination of these. The conditions for the thermal drying may be, for example, a temperature of 30° C. or higher and 200° C. or lower, and a time period of 0.5 hours or longer and 24 hours or shorter.

The mixture may be preferably a mechanically-milled material of the lanthanoid metal ion source, the alkali earth metal ion source, and the adduct ion source. That is, the mixture may be a material that is obtained by mixing the lanthanoid metal ion source, the alkali earth metal ion source, and the adduct ion source with each other using a mechanical milling process. The mechanical milling process may be performed using, for example, a planetary ball mill, a bead mill, a ball mill, or a jet mill. For example, in the case where, a planetary ball mill is used, the condition for the mechanical milling process may be a time period of 0.5 hours or longer and 48 hours or shorter and may be preferably 5 hours or longer and 24 hours or shorter.

In the heat treatment step, the prepared mixture is subjected to a heat treatment at a predetermined temperature to obtain a metal composite fluoride. The metal composite fluoride obtained at the heat treatment step may be a solid electrolyte for fluoride ion batteries. The heat treatment temperature in the heat treatment step is, for example, 200° C. or higher and 1,000° C. or lower, may be preferably 300° C. or higher, or 400° C. or higher, and may be preferably 700° C. or lower, or 600° C. or lower.

The heat treatment may include increasing the temperature to the predetermined heat treatment temperature, maintaining the heat treatment temperature, and decreasing the temperature from the heat treatment temperature. The rate of increasing the temperature to the heat treatment temperature as the rate of increasing the temperature from, for example, the room temperature may be 1° C./minute or higher and 20° C./minute or lower, may be preferably 5° C./minute or higher, and may be preferably 10° C./minute or lower. The time period of maintaining the heat treatment temperature in the heat treatment may be, for example, 1 hour or longer, and may be preferably 5 hours or longer. The time period for the heat treatment may be, for example, 48 hours or shorter, and may be preferably 20 hours or shorter, or 10 hours or shorter. The rate of decreasing the temperature from the heat treatment temperature as the rate of decreasing the temperature to, for example, the room temperature may be 1° C./minute or higher and 20° C./minute or lower.

The atmosphere used in the heat treatment step may be, for example, an inert gas atmosphere. Examples of the inert gas include a nitrogen gas and a noble gas such as argon. As to the inert gas atmosphere, the content rate of the inert gas may be, for example, 90% by volume or higher, and may be preferably 95% by volume or 98% by volume or higher, and the inert gas may be at substantially 100% by volume. “Substantially” as used herein means that the presence of any gas that is unavoidably mixed, other than the inert gas, is not eliminated. The content rate of the gas other than the inert gas may be, for example, 1% by volume or lower.

The pressure of the atmosphere used in the heat treatment step may be, for example, 0 MPa or higher and 1 MPa or lower as a gauge pressure. The heat treatment for the mixture may be performed using, for example, a tubular furnace or a furnace bottom lifting furnace.

The metal composite fluoride obtained in the heat treatment step may have a composition in which the ratio of the number of moles of the lanthanoid metal ion to the total number of moles of the lanthanoid metal ion, the alkali earth metal ion, and the adduct ion is greater than 0 and smaller than 0.6, in which the ratio of the number of moles of the alkali earth metal ion thereto is 0.4 or greater and smaller than 1.0, and in which the ratio of the number of moles of the adduct ion thereto is greater than 0 and smaller than 0.38.

### Solid Electrolyte Layer

A solid electrolyte layer includes at least the solid electrolyte material described above. The solid electrolyte layer may be prepared by, for example, pressing the solid electrolyte material. The pressure applied in the pressing can be set at, for example, 10 MPa or higher and 1,000 MPa or lower.

The solid electrolyte layer may include another component other than the solid electrolyte material as necessary. Examples of the other component include a binder, or the like. Examples of the binder may include, for example, a fluorine-based binder such as polyvinylidene fluoride (PVDF) or polytetrafluoroethylene (PTFE), a rubber-based binder such as styrene-butadiene rubber (SBR), an olefine-based binder such as polypropylene (PP) or polyethylene (PE), a cellulose-based binder such as carboxymethyl cellulose (CMC), and the like.

### Fluoride Ion Battery

A fluoride ion battery includes a solid electrolyte layer, a positive electrode, and a negative electrode. The fluoride ion battery may be a fully solid-state battery. The solid electrolyte layer included in the fluoride ion battery is described above. With the solid electrolyte layer that includes the specific solid electrolyte material and that has high ion conductivity, the fluoride ion battery may function as a fluoride ion battery even at a relatively low temperature.

The positive electrode included in the fluoride ion battery may be a positive electrode layer that includes at least a positive active material, and may further include a current collector in addition to the positive electrode layer. The positive electrode layer may further include an electrically conductive material, a binder, and the like as necessary, in addition to the positive electrode active material.

Examples of the positive electrode active material may include, for example, a single metal, an alloy, a metal oxide, and a fluoride of these. Examples of the elemental metal included in the positive electrode active material may include, for example, Cu, Ag, Ni, Co, Pb, Ce, Mn, Au, Pt, Rh, V, Os, Ru, Fe, Cr, Bi, Nb, Sb, Ti, Sn, and Zn. It is preferred that, among these, the positive electrode active material include at least one selected from the group consisting of Cu, CuFₘ, Fe, FeFₘ, Ag, and AgFₘ, where m is each independently a real number greater than 0. Other examples of the positive electrode active material may include a carbon material and a fluoride thereof. Examples of the carbon material may include, for example, black lead, coke, and a carbon nanotube. Further other examples of the positive electrode active material may include a polymer material. Examples of the polymer material may include, for example, polyaniline, polypyrrole, polyacetylene, and polythiophene.

Examples of the electrically conductive material may include, for example, a carbon material. Examples of the carbon material may include, for example, carbon black such as acetylene black, Ketjen black, furnace black, and thermal black. Examples of the binder may include, for example, a fluorine-based binder such as polyvinylidene fluoride (PVDF) or polytetrafluoroethylene (PTFE).

The negative electrode included in the fluoride ion battery may be a negative electrode layer that includes at least a negative electrode active material, and may further include a current collector in addition to the negative electrode layer. The negative electrode layer may further include an electrically conductive material, a binder, and the like as necessary, in addition to the negative electrode active material.

An optional active material may be selected that has a potential lower than that of the positive electrode active material, as the negative electrode active material. The positive electrode active material described above may therefore be used as the negative electrode active material. Examples of the negative electrode active material may include, for example, an elemental metal, an alloy, a metal oxide, and a fluoride of each of these. Examples of the metal element included in the negative electrode active material can include, for example, La, Ca, Al, Eu, Li, Si, Ge, Sn, In, V, Cd, Cr, Fe, Zn, Ga, Ti, Nb, Mn, Yb, Zr, Sm, Ce, Mg, and Pb. It is preferred that, among these, the negative electrode active material include at least one selected from the group consisting of Mg, MgFₙ, Al, AlFₙ, Ce, CeFₙ, Ca, CaFₙ, Pb, and PbFₙ, where n is each independently a real number that is greater than 0. The carbon material or the polymer material described above are also usable as the negative electrode active material. For the electrically conductive material and the binding agent, the materials same as the materials for the positive electrode layer described above are also usable.

### EXAMPLES

The present invention will be described below in detail with reference to Examples while the present invention is not limited to these Examples. The composition of the solid electrolyte material in each of Examples and Comparative Examples is the result of the composition analysis described later.

### Example 1

### Synthesis of Cs_{0.09}Ba_{0.56}La_{0.36}F_{2.27}

CsF, BaF₂, and LaF₃ were weighed to establish their molar ratios of 1:5.4:3.6. The weighed materials were thermally dried at 120° C. for 2 hours and were crushed and mixed with each other using a planetary ball mill at 600 rpm for 10 hours to obtain a mixture. The obtained mixture was subjected to a heat treatment at 600° C. for 10 hours in an argon atmosphere to obtain a solid electrolyte material of Example 1 as a metal composite fluoride.

### Example 2

### Synthesis of Cs_{0.22}Ba_{0.48}La_{0.30}F_{2.09}

A solid electrolyte material of Example 2 was obtained in the same manner as that of Example 1 except that CsF, BaF₂, and LaF₃ were weighed to establish their molar ratios of 2:4.8:3.2.

### Example 3

### Synthesis of Cs_{0.27}Ba_{0.45}La_{0.28}F_{2.01}

A solid electrolyte material of Example 3 was obtained in the same manner as that of Example 1 except that CsF, BaF₂, and LaF₃ were weighed to establish their molar ratios of 3:4.2:2.8.

### Example 4

### Synthesis of Cs_{0.09}Ba_{0.56}La_{0.35}F_{2.27}

A solid electrolyte material of Example 4 was obtained in the same manner as that of Example 1 except that the temperature of the heat treatment was changed to 400° C.

### Example 5

### Synthesis of Cs_{0.22}Ba_{0.48}La_{0.30}F_{2.09}

A solid electrolyte material of Example 5 was obtained in the same manner as that of Example 2 except that the temperature of the heat treatment was changed to 400° C.

### Example 6

### Synthesis of Cs_{0.29}Ba_{0.44}La_{0.28}F_{1.99}

A solid electrolyte material of Example 6 was obtained in the same manner as that of Example 3 except that the temperature of the heat treatment was changed to 400° C.

### Comparative Example 1

### Synthesis of Ba_{0.61}La_{0.39}F_{2.37}

A solid electrolyte material of Comparative Example 1 was obtained in the same manner as that of Example 1 except that BaF₂ and LaF₃ were weighed to establish their molar ratios of 6:4.

### Comparative Example 2

### Synthesis of Ba_{0.61}La_{0.39}F_{2.37}

A solid electrolyte material of Comparative Example 2 was obtained in the same manner as that of Comparative Example 1 except that the temperature of the heat treatment was changed to 400° C.

### Comparative Example 3

### Synthesis of Cs_{0.38}Ba_{0.38}La_{0.24}F_{1.87}

A solid electrolyte material of Comparative Example 3 was obtained in the same manner as that of Example 1 except that CsF, BaF₂, and LaF₃ were weighed to establish their molar ratios of 4:3.6:2.4.

### Comparative Example 4

### Synthesis of Cs_{0.47}Ba_{0.33}La_{0.20}F_{1.74}

A solid electrolyte material of Comparative Example 4 was obtained in the same manner as that of Example 1 except that CsF, BaF₂, and LaF₃ were weighed to establish their molar ratios of 5:3:2.

### Comparative Example 5

### Synthesis of Sr_{0.12}Ba_{0.54}La_{0.35}F_{2.35}

A solid electrolyte material of Comparative Example 5 was obtained in the same manner as that of Example 1 except that SrF₂, BaF₂, and LaF₃ were weighed to establish their molar ratios of 1:5.4:3.6.

### Comparative Example 6

### Synthesis of Sr_{0.22}Ba_{0.47}La_{0.30}F_{2.30}

A solid electrolyte material of Comparative Example 6 was obtained in the same manner as that of Example 1 except that SrF₂, BaF₂, and LaF₃ were weighed to establish their molar ratios of 2:4.8:3.2.

### Comparative Example 7

### Synthesis of Sr_{0.33}Ba_{0.41}La_{0.26}F_{2.26}

A solid electrolyte material of Comparative Example 7 was obtained in the same manner as that of Example 1 except that SrF₂, BaF₂, and LaF₃ were weighed to establish their molar ratios of 3:4.2:2.8.

### Comparative Example 8

### Synthesis of Y_{0.10}Ba_{0.55}La_{0.35}F_{2.45}

A solid electrolyte material of Comparative Example 8 was obtained in the same manner as that of Example 1 except that YF₃, BaF₂, and LaF₃ were weighed to establish their molar ratios of 1:5.4:3.6. The ion radius of yttrium is 0.104 nm or larger and 0.116 nm or smaller.

### Comparative Example 9

### Synthesis of Y_{0.20}Ba_{0.49}La_{0.31}F_{2.51}

A solid electrolyte material of Comparative Example 9 was obtained in the same manner as that of Example 1 except that YF₃, BaF₂, and LaF₃ were weighed to establish their molar ratios of 2:4.8:3.2.

### Comparative Example 10

### Synthesis of Y_{0.30}Ba_{0.43}La_{0.27}F_{2.57}

A solid electrolyte material of Comparative Example 10 was obtained in the same manner as that of Example 1 except that YF₃, BaF₂, and LaF₃ were weighed to establish their molar ratios of 3:4.2:2.8.

### Evaluation

### 1. Composition Analysis

For each of the solid electrolyte materials obtained as above, the composition of the solid electrolyte material was determined using an inductively coupled plasma (ICP) atomic emission spectroscopy analysis. For example, the solid electrolyte materials were each alkali-solved and were thereafter each hydrochloric acid-heating-solved as a preprocessing method, to measure the composition amounts of the metal ions using an inductively coupled plasma (ICP) atomic emission spectroscopy analyzer (ICP-AES: Optima 8300: manufactured by Perkin Elmer, Inc.) to determine the molar ratio of the fluoride ion in the composition assuming that the total of the composition amounts of the metal ions is 1.

### 2. Ion Conductivity Measurement

For each of the solid electrolyte materials obtained in the manner as above, a solid electrolyte layer specimen was fabricated as below. 200 mg of the solid electrolyte material was weighed and was pressed at 380 MPa to obtain the solid electrolyte layer specimen.

For the obtained solid electrolyte layer sample, measurement was performed using a high frequency impedance measurement system (an impedance analyzer E4990A-type manufactured by Keysight Technologies) and using an AC impedance method (the measurement temperature: 25° C., the applied voltage: 500 mV, the measurement frequency region: 120 MHz to 20 Hz), and the ion conductivity for the fluoride ion was calculated from the thickness of the solid electrolyte layer specimen and the resistance value on the real axis of a Cole-Cole plot.

### 3. XRD Measurement

Each of the solid electrolyte materials obtained as above was packed in an XRD glass folder to perform XRD measurement using an X-ray diffraction measuring apparatus (Miniflex 600 manufactured by Rigaku Corporation). For example, the measurement was performed using the CuKα line (λ=0.154 nm) for 2θ=200 to 600 at a scanning rate of 10°/min and at a step width: 0.02°.

The grating constant d was calculated using the Bragg equation (2d sin θ=nλ) from the angle θ of the peak position (the 1-1-1 plane) around 25°, at which the intensity was highest in the diffraction chart. The lattice constant “a” (nm) was calculated using the cubic system crystal Miller's index dₕₖ₁=a/√(h²+k²+l²) from the grating constant d.

TABLE 1

| | | | | Ion | | |
|---|---|---|---|---|---|---|
| | | Molar ratio | Lattice | conductivity | Heat | |
| | | of fluoride | constant | (25° C.) | treating | Adduct |
| | Composition | ion | a(nm) | (S/cm) | temperature | ion |
| Example 1 | Cs_{0.09}Ba_{0.56}La_{0.36}F_{2.27} | 2.27 | 0.6102 | 2.19E−04 | 600° C. | Cs |
| Example 2 | Cs_{0.22}Ba_{0.48}La_{0.30}F_{2.09} | 2.09 | 0.6108 | 4.21E−05 | 600° C. | Cs |
| Example 3 | Cs_{0.27}Ba_{0.45}La_{0.28}F_{2.01} | 2.01 | 0.6124 | 1.85E−03 | 600° C. | Cs |
| Example 4 | Cs_{0.09}Ba_{0.56}La_{0.35}F_{2.27} | 2.27 | 0.6107 | 5.92E−06 | 400° C. | Cs |
| Example 5 | Cs_{0.22}Ba_{0.48}La_{0.30}F_{2.09} | 2.09 | 0.6113 | 1.34E−03 | 400° C. | Cs |
| Example 6 | Cs_{0.29}Ba_{0.44}La_{0.28}F_{1.99} | 1.99 | 0.6125 | 2.68E−04 | 400° C. | Cs |
| Comparative | Ba_{0.61}La_{0.39}F_{2.37} | 2.37 | 0.6090 | 8.06E−07 | 600° C. | None |
| Example 1 | | | | | | |
| Comparative | Ba_{0.61}La_{0.39}F_{2.37} | 2.37 | 0.6084 | 2.69E−06 | 400° C. | None |
| Example 2 | | | | | | |
| Comparative | Cs_{0.38}Ba_{0.38}La_{0.24}F_{1.87} | 1.87 | 0.6133 | 1.38E−07 | 600° C. | Cs |
| Example 3 | | | | | | |
| Comparative | Cs_{0.47}Ba_{0.33}La_{0.20}F_{1.74} | 1.74 | 0.6173 | 9.12E−08 | 600° C. | Cs |
| Example 4 | | | | | | |
| Comparative | Sr_{0.12}Ba_{0.54}La_{0.35}F_{2.35} | 2.35 | 0.6061 | 1.07E−06 | 600° C. | Sr |
| Example 5 | | | | | | |
| Comparative | Sr_{0.22}Ba_{0.47}La_{0.30}F_{2.30} | 2.30 | 0.6022 | 4.53E−07 | 600° C. | Sr |
| Example 6 | | | | | | |
| Comparative | Sr_{0.33}Ba_{0.41}La_{0.26}F_{2.26} | 2.26 | 0.5991 | 3.65E−07 | 600° C. | Sr |
| Example 7 | | | | | | |
| Comparative | Y_{0.10} Ba_{0.55}La_{0.35}F_{2.45} | 2.45 | 0.6040 | 5.05E−07 | 600° C. | Y |
| Example 8 | | | | | | |
| Comparative | Y_{0.20} Ba_{0.49} La_{0.31}F_{2.51} | 2.51 | 0.5989 | 3.50E−07 | 600° C. | Y |
| Example 9 | | | | | | |
| Comparative | Y_{0.30} Ba_{0.43}La_{0.27}F_{2.57} | 2.57 | 0.5954 | 4.36E−08 | 600° C. | Y |
| Example 10 | | | | | | |

In Examples 1 to 3, the lattice constant increased corresponding to an increase of the content of Cs, and accordingly the ion conductivity for the fluoride ion was improved. Thus, it is thought that the result of the increase of the crystal size contributes to the ion conductivity. In contrast, in Comparative Examples 3 and 4, the ion conductivity resulted in a significant decrease while the lattice constant increased. This is thought to be because the reduction in the rate of the number of moles of the fluoride ion to the total number of moles of the metal ions caused the F2 sites (the excessive fluorine sites) to be disappeared, resulting in change of the ion conduction mechanism. In Comparative Examples 5 to 10, corresponding to a decrease of the lattice constant, the ion conductivity also resulted in a decrease.

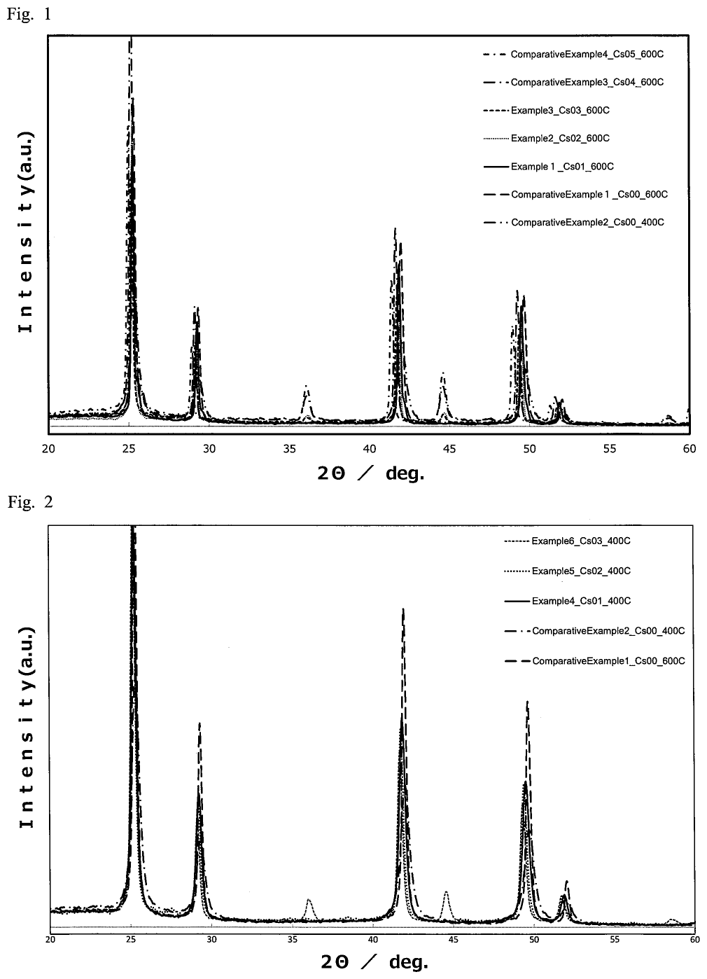

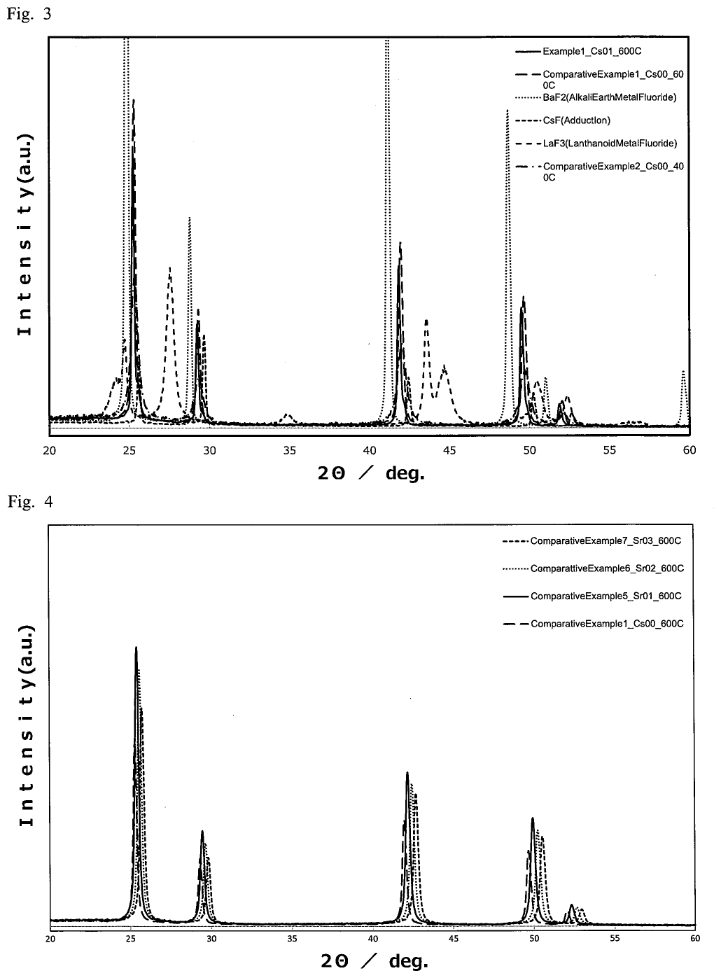

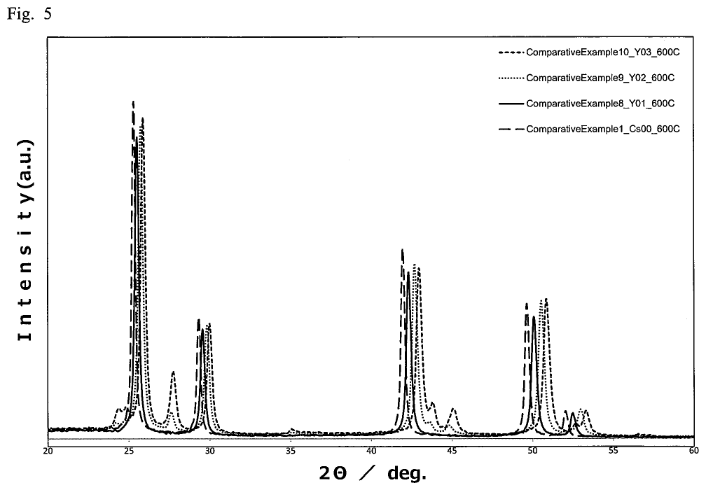

FIG. 1 to FIG. 5 show XRD spectra of the solid electrolyte materials obtained as above. The overview of the peaks observed with the solid electrolyte materials will be described below.

It was able to be confirmed that the solid electrolyte material of Example 1 had peaks at positions of 2θ=25.247°, 29.234°, 41.831°, 49.501°, and 51.854°. It was able to be confirmed that the solid electrolyte material thereof had a fluorite type structure based on the fact that the solid electrolyte material thereof had peaks at the four positions of 2θ=25.3°+1°, 29.301°, 41.9°±1°, and 49.6°±1°.

It was able to be confirmed that the solid electrolyte material of Example 2 had peaks at positions of 2θ=25.226°, 29.208°, 41.786°, 49.437°, and 51.794°.

It was able to be confirmed that the solid electrolyte material of Example 3 had peaks at positions of 2θ=25.156°, 29.133°, 41.700°, 49.344°, and 51.191°.

It was able to be confirmed that the solid electrolyte material of Example 4 had peaks at positions of 2θ=25.230°, 29.215°, 41.818°, 49.483°, and 51.851°.

It was able to be confirmed that the solid electrolyte material of Example 5 had peaks at positions of 2θ=25.207°, 29.186°, 41.747°, 49.372°, and 51.768°.

It was able to be confirmed that the solid electrolyte material of Example 6 had peaks at positions of 2θ=25.154°, 29.110°, 41.653°, 49.277°, and 51.666°.

It was able to be confirmed that the solid electrolyte material of Comparative Example 1 had peaks at positions of 2θ=25.299°, 29.302°, 41.946°, 49.647°, and 52.021°.

It was able to be confirmed that the solid electrolyte material of Comparative Example 2 had peaks at positions of 2θ=25.327°, 29.294°, 41.982°, 49.683°, and 52.070°.

It was able to be confirmed that the solid electrolyte material of Comparative Example 3 had peaks at positions of 2θ=25.121°, 29.092°, 41.615°, 49.238°, and 51.574°.

It was able to be confirmed that the solid electrolyte material of Comparative Example 4 had peaks at positions of 2θ=24.953°, 25.271°, 28.923°, 41.359°, 48.938°, and 51.278°.

As to the solid electrolyte materials of Examples 1 to 3 and Comparative Examples 3 and 4, all the peaks were shifted to the low angle side compared to those of the solid electrolyte material of Comparative Example 1, and the peaks at 25.590°, 29.663°, 42.419°, 50.231°, and 52.607° that are the peaks of CsF were not able to be confirmed. It can therefore be seen that Cs was solid-solved in the crystal structure of Ba_{0.61}La_{0.39}F_{2.37} of the fluorite type structure. As to the solid electrolyte materials of Examples 4 to 6, it was confirmed that all the peaks were also shifted to the low angle side compared to those of the solid electrolyte material of Comparative Example 2.

It was able to be confirmed that the solid electrolyte material of Comparative Example 5 had peaks at positions of 2θ=25.421°, 29.445°, 42.166°, 49.907°, and 52.306°.

It was able to be confirmed that the solid electrolyte material of Comparative Example 6 had peaks at positions of 2θ=25.588°, 29.629°, 42.434°, 50.219°, and 52.634°.

It was able to be confirmed that the solid electrolyte material of Comparative Example 7 had peaks at positions of 2θ=25.725°, 29.804°, 42.665°, 50.501°, and 52.916°.

As to the solid electrolyte materials of Comparative Examples 5 to 7, all the peaks were shifted to the high angle side compared to those of Comparative Example 1 and the peaks at 26.571°, 30.777°, 44.090°, 52.232°, and 54.750° that are the peaks of SrF₂ were not able to be confirmed. It can therefore be seen that Sr was solid-solved in the crystal structure of Ba_{0.61}La_{0.39}F_{2.37} of the fluorite type structure.

It was able to be confirmed that the solid electrolyte material of Comparative Example 8 had peaks at positions of 2θ=25.510°, 29.530°, 42.298°, 50.074°, and 52.483°.

It was able to be confirmed that the solid electrolyte material of Comparative Example 9 had peaks at positions of 2θ=27.581°, 29.811°, 42.685°, 50.524°, and 52.970°.

It was able to be confirmed that the solid electrolyte material of Comparative Example 10 had peaks at positions of 2θ=25.884°, 29.979°, 42.960°, 50.836°, and 53.286°.

As to the solid electrolyte materials of Comparative Example 8, all the peaks were shifted to the high angle side compared to those of Comparative Example 1 and the peaks at 23.963°, 24.537°, 27.809°, 30.925°, 34.779°, 35.994°, 37.189°, 38.546°, 40.958°, 43.849°, 45.553°, 46.924°, 47.528°, 48.982°, 49.41°, 52.212°, 53.344°, 54.935°, 57.872°, and 59.581° that are the peaks of YF₃ were not able to be confirmed. It can therefore be seen that Y was solid-solved in the crystal structure of Ba_{0.61}La_{0.39}F_{2.37} of the fluorite structure. As to the solid electrolyte materials of Comparative Examples 9 and 10, some of the above YF₃ peaks were able to be confirmed while the peaks of Ba_{0.61}La_{0.39}F_{2.37} of the fluorite structure were shifted to the high angle side. It can therefore be thought that Y was not fully solid-solved while a certain amount of Y was solid-solved in Ba_{0.61}La_{0.39}F_{2.37} of the fluorite type structure.

The disclosure of JP2021196398A (the filing date: Dec. 2, 2021) is incorporated herein in its entirety by reference. All of the literatures, patent applications, and the technical standards described herein are incorporated herein by reference at the equal level of the case where it is described in detail and individually for each of the literatures, the patent applications, and the technical standards, that each of them is incorporated herein by reference.

What is claimed is:

1.-14. (canceled)

15. A solid electrolyte material for fluoride ion batteries, the solid electrolyte material comprising:
a metal composite fluoride that comprises, as its main phase, a crystal structure comprising an adduct ion in a fluorite type structure, the fluorite structure comprising a fluoride ion, a lanthanoid metal ion, and an alkali earth metal ion,
wherein the adduct ion has an ion radius larger than an ion radius of the alkali earth metal ion, and
wherein the metal composite fluoride has a composition in which:
a ratio of a number of moles of the fluoride ion to a total number of moles of the lanthanoid metal ion, the alkali earth metal ion, and the adduct ion is greater than 1.87 and is smaller than 3, and
a ratio of a number of moles of the adduct ion to a number of moles of the alkali earth metal ion is smaller than 1.

16. The solid electrolyte material according to claim 15, wherein
the metal composite fluoride has a composition in which, to the total number of moles of the lanthanoid metal ion, the alkali earth metal ion, and the adduct ion,
a ratio of a number of moles of the lanthanoid metal ion is greater than 0 and smaller than 0.6,
a ratio of the number of moles of the alkali earth metal ion is 0.4 or greater and smaller than 1.0, and
a ratio of the number of moles of the adduct ion is greater than 0 and smaller than 0.38.

17. The solid electrolyte material according to claim 15, wherein
the metal composite fluoride has a composition represented by Formula (1) as below,
Ln_{1-x-y}MₓA_{y}F_{z} (1), wherein
Ln represents the lanthanoid metal ion,
M represents the alkali earth metal ion,
A represents the adduct ion, and
x, y and z satisfy 0<x<1, 0<y<1, 0<x+y<1, and 1.87<z<3.

18. The solid electrolyte material according to claim 17, wherein
x and y in the Formula (1) satisfy 0.4≤x<1, 0.4<x+y<1, and 0<y<0.38.

19. The solid electrolyte material according to claim 15, wherein
the lanthanoid metal ion comprises a lanthanum ion.

20. The solid electrolyte material according to claim 15, wherein
the alkali earth metal ion comprises a barium ion.

21. The solid electrolyte material according to claim 15, wherein
the adduct ion comprises a cesium ion.

22. A solid electrolyte layer for fluorite ion batteries, the solid electrolyte layer comprising the solid electrolyte material according to claim 15.

23. A fluoride ion battery comprising:
the solid electrolyte layer according to claim 22;
a positive electrode; and
a negative electrode.

24. A method for producing a solid electrolyte for fluoride ion batteries, the method comprising:
preparing a mixture that includes a lanthanoid metal fluoride, an alkali earth metal fluoride, and a fluoride of an adduct ion at such content ratios that, assuming that a content of a lanthanoid metal ion contained in the lanthanoid metal fluoride is p mol, a content of an alkali earth metal ion contained in the alkali earth metal fluoride is q mol, a content of the adduct ion contained in the fluoride of the adduct ion is r mol, and a valence of the adduct ion is n, p, q, r and n satisfy 1.87<(3p+2q+nr)/(p+q+r)<3; and
heat-treating the mixture at a temperature of 200° C. or higher and 1,000° C. or lower to obtain a metal composite fluoride,
wherein the adduct ion has an ion radius larger than that of the alkali earth metal ion, and
wherein the metal composite fluoride has, as its main phase, a crystal structure that comprises the adduct ion in a fluorite type structure.

25. The method for producing a solid electrolyte according to claim 24, wherein
in the mixture, a ratio of the content of the lanthanoid metal ion to the content of the alkali earth metal ion is greater than 0 and is 1.5 or smaller.

26. The method for producing a solid electrolyte according to claim 24, wherein
in the mixture, a ratio of the content of the adduct ion to a total content of the lanthanoid metal ion, the alkali earth metal ion, and the adduct ion is greater than 0 and smaller than 0.4.

27. The method for producing a solid electrolyte according to claim 24, wherein
the mixture is a mechanically-milled material containing the lanthanoid metal fluoride, the alkali earth metal fluoride, and the fluoride of the adduct ion.

28. The method for producing a solid electrolyte according to claim 24, wherein
the metal composite fluoride has a composition in which, to a total number of moles of the lanthanoid metal ion, the alkali earth metal ion, and the adduct ion,
a ratio of a number of moles of the lanthanoid metal ion is greater than 0 and is smaller than 0.6,
a ratio of a number of moles of the alkali earth metal ion is 0.4 or greater and smaller than 1.0, and
a ratio of a number of moles of the adduct ion is greater than 0 and smaller than 0.38.
